(19) United States
(12) Patent Application Publication
(10) Pub. No.: US 2025/0366446 A1
(43) Pub. Date: Dec. 4, 2025

(54) Apparatus and Method for Forming Oyster Reefs

(71) Applicant: THE ZIP PROJECT LLC, Tallahassee, FL (US)

(72) Inventors: Katherine E. Stewart, Tallahassee, FL (US); Mike Keramidas, Tallahassee, FL (US)

(21) Appl. No.: 18/677,938

(22) Filed: May 30, 2024

(51) Int. Cl. A01K 61/73; A01K 61/54

(52) U.S. Cl. CPC A01K 61/73; A01K 61/54

(57) ABSTRACT

Disclosed is a device and an associated method for promoting the formation of oyster reefs. The device includes a number of interconnected wire enclosures. The wire enclosures house non-living oyster shells. These oyster shells attract oyster larvae and promote reef formations. The enclosures are preferably interconnected to form a closed pen with the bottom of the pen formed by a biodegradable mesh netting. Additional non-living oyster shells can be positioned over top of the netting. The wire enclosures serve to protect larvae that attaches to the oyster shells. This, in turn, ensures that oyster reef formations are promoted.

### TECHNICAL FIELD

This disclosure relates to an apparatus and method for forming oyster reefs. More specifically, the disclosure relates to an apparatus and an associated method for storing and submerging oyster shells as a means for attracting, growing, and protecting oyster larvae and promoting the growth of oyster reefs.

### BACKGROUND OF THE INVENTION

Oyster reefs are large conglomerations of oysters that exist within coastal water ways. Oyster reefs are sometimes referred to as oyster beds, oyster banks, or oyster bottoms. Oyster reefs are formed when oyster larvae attach to and grow upon submerged marine formations, such as concrete slabs or rocky areas. Oyster larvae can also attach to the shells of other living and non-living oysters. Over time, the attached larvae mature into full grown oysters and form large oyster reefs. Oyster reefs are beneficial to both coastal regions and surrounding marine life and form an essential part of underwater ecosystems. However, due to coastal degradation, overharvesting, and human development oyster reefs have seen significant declines around the world. These declines have, in turn, negatively impacted coastal water ways and the surrounding marine life. In view of this, efforts have been made over the years to foster the growth of oyster reefs.

For example, U.S. Pat. No. 5,269,254 to Gagliano et al. discloses a method and apparatus for growing an oyster reef. The apparatus of Gagliano includes a cultch material that contains seed oysters. These seed oysters are positioned on vertically arranged and water permeable panels. Water with conditions favorable to oyster growth is then permitted to flow through the vertically arranged panels. Furthermore, U.S. Pat. Pub. 2016/0212978 to Matthews, III et al. discloses a shellfish trap system for developing a reef. The trap system includes a growing assembly having first and second protective layers. The first protective layer is removed from the trap system after the completion of a first developmental stage. The growing assembly includes a material that is conducive for shellfish in the pediveliger larvae stage to attach to.

Although the background art achieves certain notable objectives, all of the background art suffers from certain drawbacks. Namely, the background art does not provide a device that is economical, environmentally friendly, easy to deploy, and that effectively promotes reef formation. The apparatus and method of the present disclosure successfully overcome these and other drawbacks present in the background art.

### SUMMARY OF THE INVENTION

This disclosure relates to an apparatus for forming oyster reefs that is economical, environmentally friendly, and easy to deploy.

The disclosed apparatus has several important advantages. For example, the device uses oyster shells to attract oyster larvae and promote reef formation.

A further possible advantage is achieved by housing the oyster shells in one or more wire cages, with the cages serving to protect the larvae from marine life and ocean tides.

Still yet another possible advantage is attained by interconnecting several wire cages to form a pen, with the pen being used to store additional oyster shells.

Another advantage of the apparatus and method is realized by providing a series of interconnected wire cages, with a bottom formed from a biodegradable mesh netting.

These and other advantages are provided by an apparatus for forming oyster reefs, including a series of wire cages, with each wire cage having an interior area, the interior area of each wire cage being filled with oyster shells. The series of wire cages are secured together to form a closed pen. A mesh netting is secured to the series of wire cages to form a floor of the pen. Additional oyster shells can be supplied over top of the floor.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a perspective view of the apparatus for forming oyster reefs.

FIG. 2 is a perspective view of the device of FIG. 1 with the wire cages and pen filled with oyster shells.

FIG. 3 is a perspective view of the apparatus as submerged within a body of water.

FIG. 4 is a perspective view of an alternative embodiment of the apparatus for forming oyster reefs.

FIG. 5 is a perspective view of the alternative embodiment shown filled with oyster shells.

FIG. 6 is a perspective view of the alternative embodiment submerged within a body of water.

FIG. 7 is a further embodiment illustrating a series of four cages tied together to form a larger apparatus for forming oyster reefs.

The various reference numerals refer to similar parts throughout the several views of the drawings.

### DETAILED DESCRIPTION OF THE DRAWINGS

The present disclosure relates to an apparatus and an associated method for promoting the formation of oyster reefs within coastal water ways. The apparatus includes a number of interconnected wire enclosures for housing oyster shells. These oyster shells attract oyster larvae and promote the growth of larger reef formations. In one embodiment of the invention, the wire enclosures are interconnected in an end-to-end fashion to form a closed pen. The floor of the pen is provided via a mesh netting. A biodegradable netting is preferred. Additional oyster shells can be positioned upon the floor of the pen. The various oyster shells, both within the wire enclosures and upon the floor, serve as surfaces to attract oyster larvae and allow them to mature into full grown oysters. The wire enclosures protect the larvae from marine life and ocean currents. This, in turn, ensures that oyster reef formations are promoted.

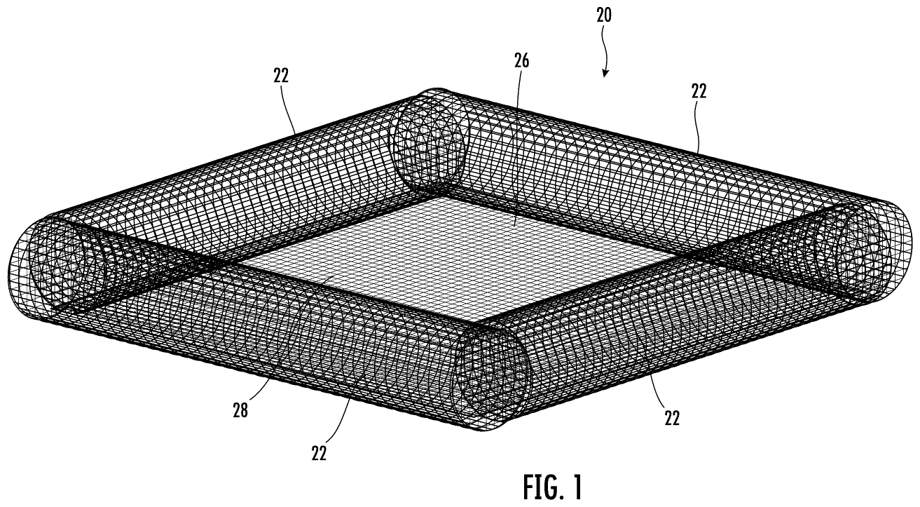

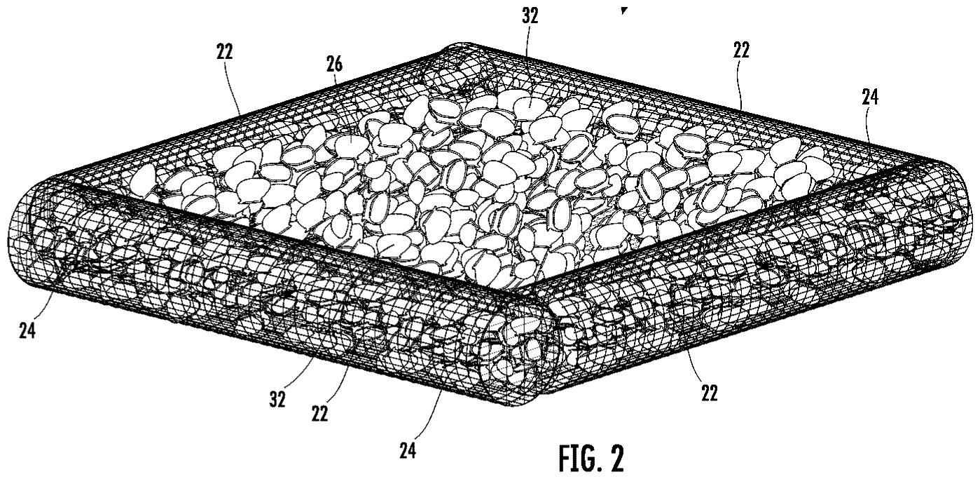

With reference to FIG. 1, the apparatus (20) for promoting reef formation is depicted. Device (20) is shown without any shells being positioned upon or within device (20). Device (20) is ultimately adapted to be completely or partially submerged under water where it interacts with marine life and ocean currents. In the illustrated embodiment, device (20) is formed from four, cylindrically shaped wire cages (22). Cages (22) can be made, for example, from welded wire. The wire can be of various gauges. After cylindrical cages (22) are formed, the ends of each cage (22) are preferably closed off with additional segments of wire mesh. The result is a completely enclosed cage (22) within a hollow interior area. Prior to the ends being closed, cages (22) can be filled with oyster shells. In a non-limiting example, each wire cage (22) is approximately 4.5 feet long, 6 inches high, and houses approximately 5 gallons of non-living oyster shells (24) (FIG. 2). These dimensions are provided for illustrative purposes and the use cages having other shapes, sizes, and configurations, and made from other materials is within the scope of the present disclosure.

As illustrated in FIGS. 1-2, the four cylindrical wire cages (22) are secured in an end-to-end fashion to form a larger rectangular pen (26). The individual wire cages (22) can be joined by lashing together adjacent ends within tie-wire and plyers. Other means of joining the ends will be readily apparent to those of ordinary skill in the art. Once the ends are secured together, a mesh netting (28) is secured to the bottom of each cage (22). Again, mesh netting (28) can be secured to the cages (22) via tie-wire or similar type fasteners. Regardless of how it is secured, mesh netting (28) is sufficient to form a lower floor of the pen (26). In the depicted embodiment, given that each cage (22) is approximately 4.5 feet long, once assembled, the overall apparatus (20) is approximately 4.5 feet long, 5.5 feet wide. This makes mesh netting (28) large enough to support approximately 10 gallons of oyster shells (32). It is preferable that the shells (32) supported upon netting (28) do not extend to a height that is higher that the height of the surrounding wire cages (22).

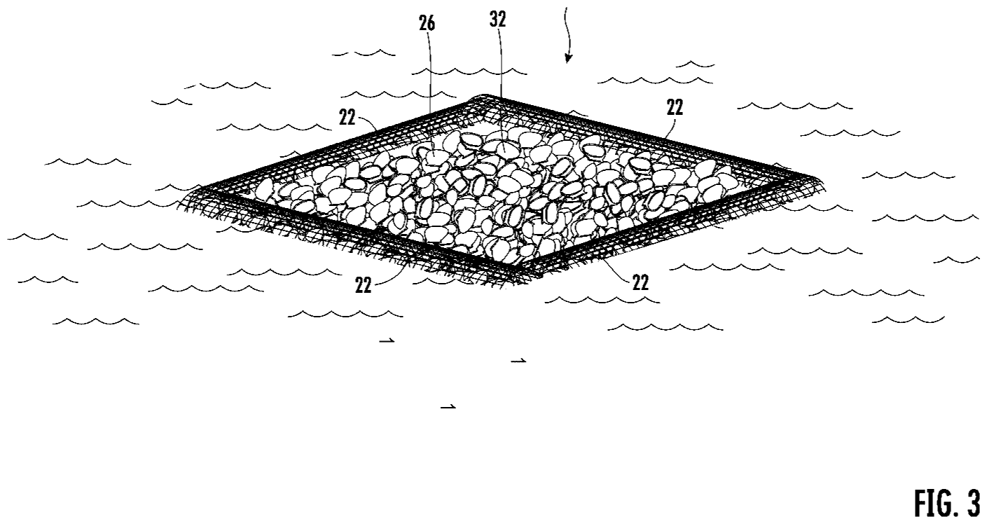

In use, the individual cages (22) are formed and filled with non-living oyster shells (24) and thereafter their ends are closed with additional wire. The ends of the cages (22) are then secured together. Mesh netting (28) is thereafter used to form a floor between the various cages (22). Next, additional oyster shells (32) are added over top of the netting (28). Thereafter, as illustrated in FIG. 3, the entire assembled apparatus (20) is submerged. Once under water, oyster shells (24) are protected via wire cages (22). Oyster shells (34) within the pen (26) are also protected by the height of the surrounding cages (22). Over time, oyster larvae attach to the shells (24, 32), both within cages (22) and upon netting (28), and an oyster reef is built up. In this manner, apparatus (20) protects the growing oyster larvae from both marine life and any ocean currents.

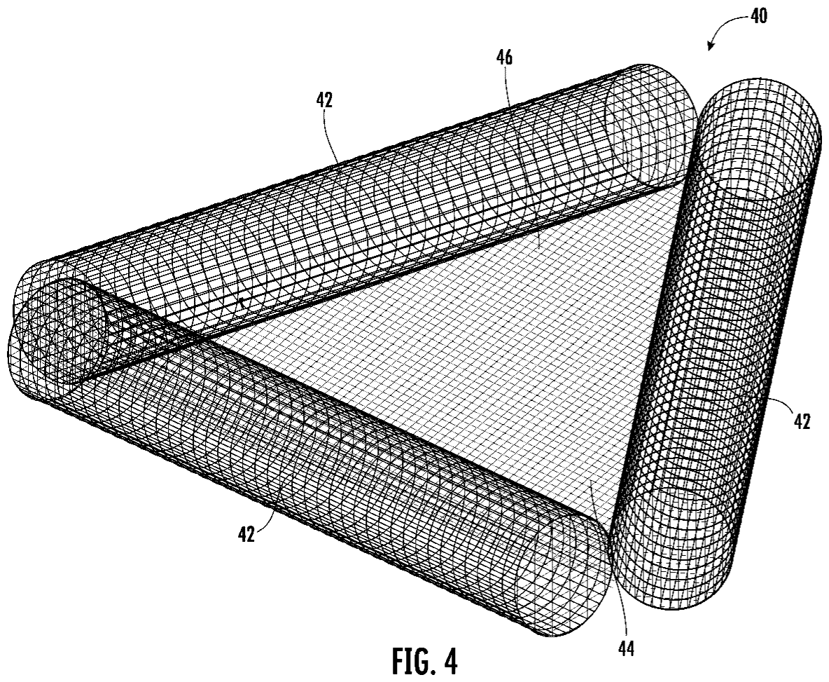

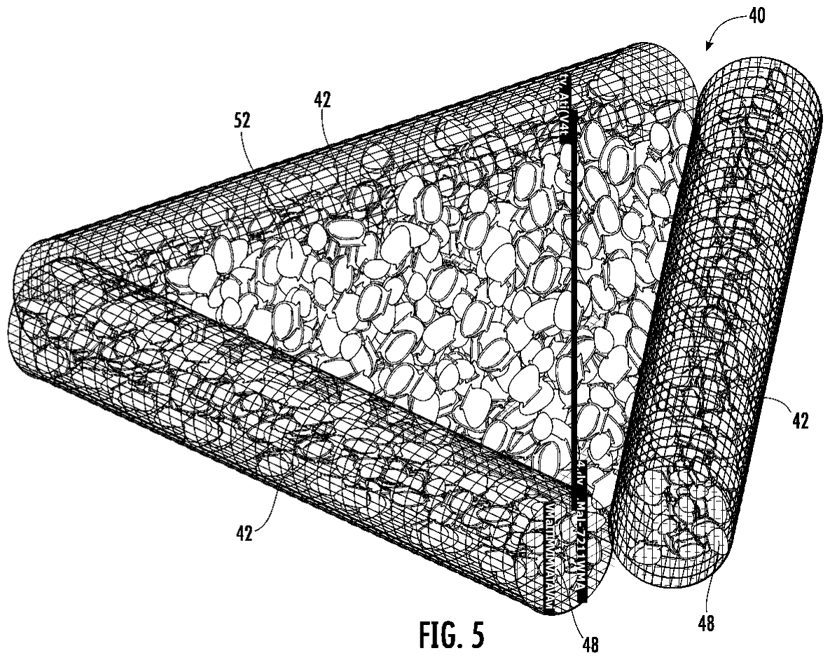

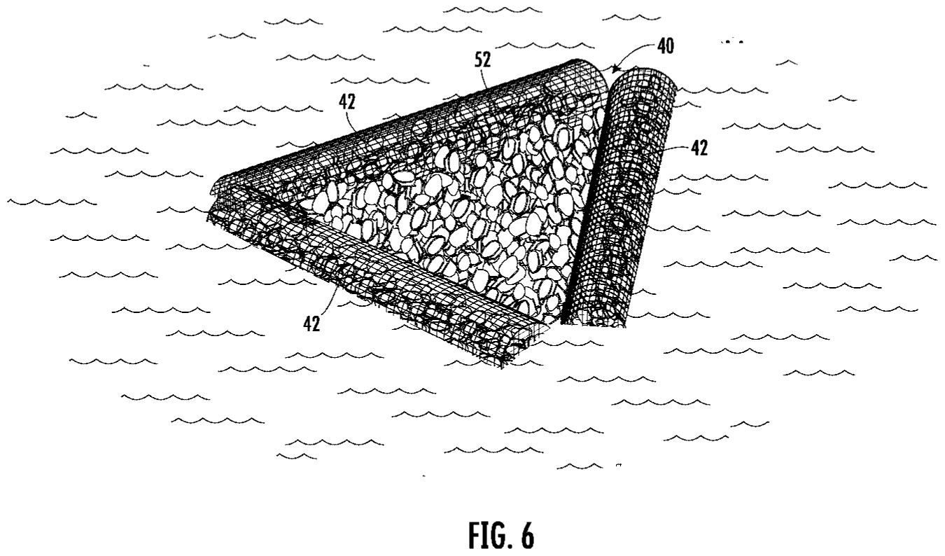

An alternative embodiment of the present disclosure is illustrated in FIGS. 4-6. This embodiment is the same in most respects to the embodiment of FIGS. 1-3. However, FIGS. 4-6 illustrate an apparatus (40) that is formed from three cylindrical cages (42) that are secured together to form a triangular pen (44). A layer of mesh netting (46) is provided at the bottom of pen (44). Cages (42) are filled with oyster shells (48) and additional oyster shells (52) are provided over top of netting (46). As illustrated in FIG. 6, the entire apparatus (40) is then submerged to promote oyster reef formation.

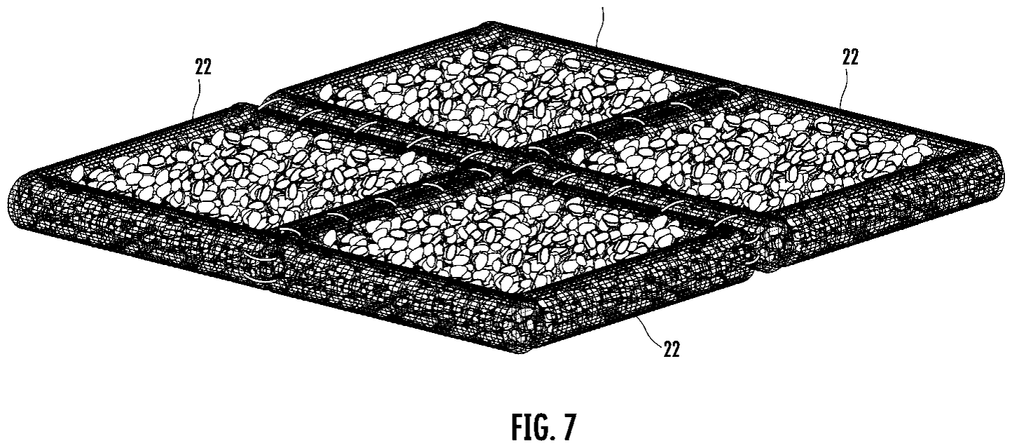

FIG. 7 illustrates another embodiment of the present disclosure. As illustrated a series of four wire cages (22) are connected to one another to form a larger apparatus (20). The individual cages (22) can be connected along their respective edges via zip ties or similar fasteners. Any number of cages (22) can be fitted together in a variety of configurations to provide a sufficiently large oyster reef.

Those of ordinary skill in the art will appreciate that the present disclosure is not limited to any specific geometry or configuration and that the principles of the invention can be readily achieved via any of a wide variety of configurations, shapes, and sizes. Likewise, the present disclosure is not limited to the use of oyster shells, and the cages and pen can be filled with other types of mollusks or shells thereof.

Although this disclosure has been described in terms of certain embodiments and generally associated methods, alterations and permutations of these embodiments and methods will be apparent to those skilled in the art. Accordingly, the above description of example embodiments do not define or constrain this disclosure. Other changes, substitutions, and alterations are also possible without departing from the spirit and scope of this disclosure.

What is claimed is:

1. An apparatus for use in forming oyster reefs, the apparatus comprising:
a series of wire cages, each wire cage having an interior area, the interior area of each wire cage being filled with oyster shells, the series of wire cages being secured together to form a closed pen;
a mesh netting secured to the series of wire cages to form a floor of the pen.

2. The device as described in claim 1 wherein a series of four wire cages are utilized to form a rectangular pen.

3. The device as described in claim 1 wherein a series of three wire cages are utilized to form a triangular pen.

4. The device as described in claim 1 wherein the mesh netting is made primarily from a biodegradable material.

5. The device as described in claim 1 wherein additional oyster shells are positioned over the floor of the pen.

6. The device as described in claim 1 wherein each of the wire cages has a height and further comprising additional oyster shells positioned over the floor of the pen with the height of the shells on the floor of the pen being less than the height of the wire cages.

7. An apparatus for use in attracting and protecting oyster larvae and for forming oyster reefs, the apparatus adapted to be submerged in water with marine life and ocean tides, the device comprising in combination:
four wire cages, each cage having a cylindrical shape, a height, an interior area, and closed opposing ends, the interior area of each wire cage being filled with non-living oyster shells, the cylindrical wire cages being secured in an end-to-end fashion to form a rectangular pen, the rectangular pen having lower end;
a biodegradable mesh netting secured to the lower end of the pen and forming a floor, additional oyster shells positioned over the floor and extending to a height that is not greater than the height of the wire cages;
whereby when the device is submerged oyster larvae attach to the oyster shells, with the oyster larvae being protected from the marine life and the ocean tides by the wire cages.

8. The apparatus as described in claim 7 wherein each of the wire cages is large enough to house approximately 5 gallons of non-living oysters.

9. The apparatus as described in claim 7 wherein the mesh netting is large enough to support approximately 10 gallons of non-living oysters.

10. A method for forming an oyster reef, the method utilizing a plurality of wire cages, oyster shells, and a mesh netting, the method comprising the following steps:
filling each of the plurality of wire cages with a portion of the oyster shells, and thereafter closing the ends of each of the plurality of wire cages;
joining each of the plurality of wire cages together in an end-to-end relationship to form a pen;
securing the mesh netting to the plurality of wire cages to form a floor of the pen;
depositing the remaining oyster shells over top of the mesh netting;
submerging the interconnected wire cages with the mesh netting into a body of water, whereby oyster larvae attach to the oyster shells, with the oyster larvae being protected by the wire cages.

11. The method as described in claim 10 wherein the oyster shells are deposited over the mesh netting to a height that is less than the height of the plurality of wire cages.

12. The method as described in claim 10 wherein the mesh netting is biodegradable.

13. The method as described in claim 10 wherein the plurality of wire cages are joined together by wire ties.

14. The method as described in claim 1 wherein each of the wire cages is filled with approximately 5 gallons of non-living oysters.

15. The method as described in claim 1 wherein approximately 10 gallons of non-living oysters are deposited upon the mesh netting.

16. The device as described in claim 1 wherein a number of separate apparatuses are interconnected via zip ties.

17. The device as described in claim 7 wherein a number of separate apparatuses are interconnected via zip ties.
